(19) United States
(12) Patent Application Publication
(10) Pub. No.: US 2011/0170882 A1
(43) Pub. Date: Jul. 14, 2011

(54) STICKING PREVENTING DEVICE, IMAGE FORMING APPARATUS, AND IMAGE FORMING METHOD

(75) Inventor: Hirotaka Matsumoto, Kanagawa (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/956,259

(22) Filed: Nov. 30, 2010

Related U.S. Application Data
(60) Provisional application No. 61/294,154, filed on Jan. 12, 2010.

(51) Int. Cl. G03G 15/00

(52) U.S. Cl. 399/16; 399/405

(57) ABSTRACT

An image forming apparatus includes a sticking preventing device including a main conveying path connected from a fixing device, a first conveying path connected to the main conveying path, a second conveying path branching from the main conveying path and having a conveying route longer than that of the first conveying path, a switching device provided at a branching point of the first conveying path and the second conveying path and configured to switch a recording-medium conveying route to the first conveying path and the second conveying path, and a temperature sensor provided above a discharge port of the first conveying path and a discharge port of the second conveying path, and a control unit configured to, if the temperature of a recording medium to be discharged detected by the temperature sensor is equal to or higher than the temperature at which sticking occurs, displace the switching device to switch the conveying route from the first conveying path to the second conveying path.

### CROSS-REFERENCE TO RELATED APPLICATIONS

This application is based upon and claims the benefit of priority from the prior the U.S. Patent Application No. 61/294154, filed on Jan. 12th, 2010, and the entire contents of which are incorporated herein by reference.

### FIELD

Embodiments described herein relate generally to a sticking preventing device, an image forming apparatus, and an image forming method.

### BACKGROUND

An electronic image forming apparatus such as a copy machine heats and presses, after transferring a developer onto a recording medium, the recording medium with a fixing device to fix a developer image on the recording medium. The fixing device includes a heating roller having a heater on the inside thereof. In recent years, according to the rise in consciousness concerning energy saving, the image forming apparatus includes a heating roller of an energy saving type having small thickness.

However, the heating roller of the energy saving type has a characteristic that warm-up time can be reduced and, on the other hand, a temperature change is large. Therefore, if image formation is continuously performed on a large number of recording media, the temperature of the recording media is high when the recording media are discharged. If the image formation is performed on both sides of the recording media, in some cases, the developer on the recording medium discharged earlier and the developer on the recording medium discharged later stick together, i.e., sticking occurs.

For the purpose of energy saving, in some cases, a developer having a low melting point is used in the image forming apparatus in order to fix the developer at low temperature. In this case, the temperature of the recording media at which the sticking occurs falls and it takes time until the temperature of the recording media falls below this temperature. Therefore, a frequency of occurrence of the sticking increases.

### BRIEF DESCRIPTION OF THE DRAWINGS

FIG. 1 is a diagram of the configuration of an image forming apparatus;

FIG. 2 is a side view of a sticking preventing device in which a recording medium is discharged through a first conveying path;

FIG. 3 is a side view of the sticking preventing device in which a recording medium is discharged through a second conveying path;

FIG. 4 is a block diagram of the configuration of the image forming apparatus;

FIG. 5 is a graph of the temperature of a recording medium to be discharged in the related art;

FIG. 6 is a graph of a temperature change of a recording medium to be discharged in the image forming apparatus;

FIG. 7 is a flowchart for explaining control of a conveying route in an image forming apparatus according to a first embodiment;

FIG. 8 is a diagram of a graph of a relation between the temperature of a recording medium to be discharged and the number of fed recording media in the first embodiment;

FIG. 9 is a table of sticking occurrence states at the temperatures of recording media to be discharged and the numbers of discharged recording media in the related art;

FIG. 10 is a flowchart for explaining control of a conveying route in an image forming apparatus according to a second embodiment;

FIG. 11 is a diagram of a graph of a relation between the temperature of a recording medium to be discharged and the number of fed recording media in the second embodiment;

FIG. 12 is a table of sticking occurrence states at time for continuous paper feed on both sides and the numbers of discharged recording media in the related art;

FIG. 13 is a flowchart for explaining control of a conveying route in an image forming apparatus according to a third embodiment; and

FIG. 14 is a diagram of a graph of a relation between the temperature of a recording medium to be discharged and the number of fed recording media in the third embodiment.

### DETAILED DESCRIPTION

Throughout this description, the embodiments and examples shown should be considered as exemplars, rather than limitations on the apparatus and methods of the present embodiments.

An embodiment of a sticking preventing device, an image forming apparatus, and an image forming method is explained in detail below with reference to the accompanying drawings. The image forming apparatus is a copying machine, a MFP (Multifunction Peripheral), a printer, or the like.

In general, according to one embodiment, a sticking preventing device includes: a main conveying path connected to a recording-medium conveying route downstream in a recording medium conveying direction of a fixing device; a first conveying path connected to the main conveying path; a second conveying path branching from the main conveying path and having a conveying route longer than that of the first conveying path; a switching device provided at a branching point of the first conveying path and the second conveying path and configured to switch the recording-medium conveying route to the first conveying path and the second conveying path; and a temperature sensor provided above a discharge port of the first conveying path and a discharge port of the second conveying path configured to detect the temperature of a recording medium to be discharged.

According to another embodiment, an image forming apparatus 1 includes: an image forming unit configured to form an image on a recording medium; a fixing device configured to heat and press the recording medium having the image formed thereon; a main conveying path connected to a recording-medium conveying route downstream in a recording medium conveying direction of the fixing device; a first conveying path connected to the main conveying path; a second conveying path branching from the main conveying path and having a conveying route longer than that of the first conveying path; a switching device provided at a branching point of the first conveying path and the second conveying path and configured to switch the recording-medium conveying route to the first conveying path and the second conveying path; a temperature sensor provided above a discharge port of the first conveying path and a discharge port of the second conveying path and configured to detect the temperature of the recording medium to be discharged; and a control unit configured to control the switching device. Configuration of the image forming apparatus

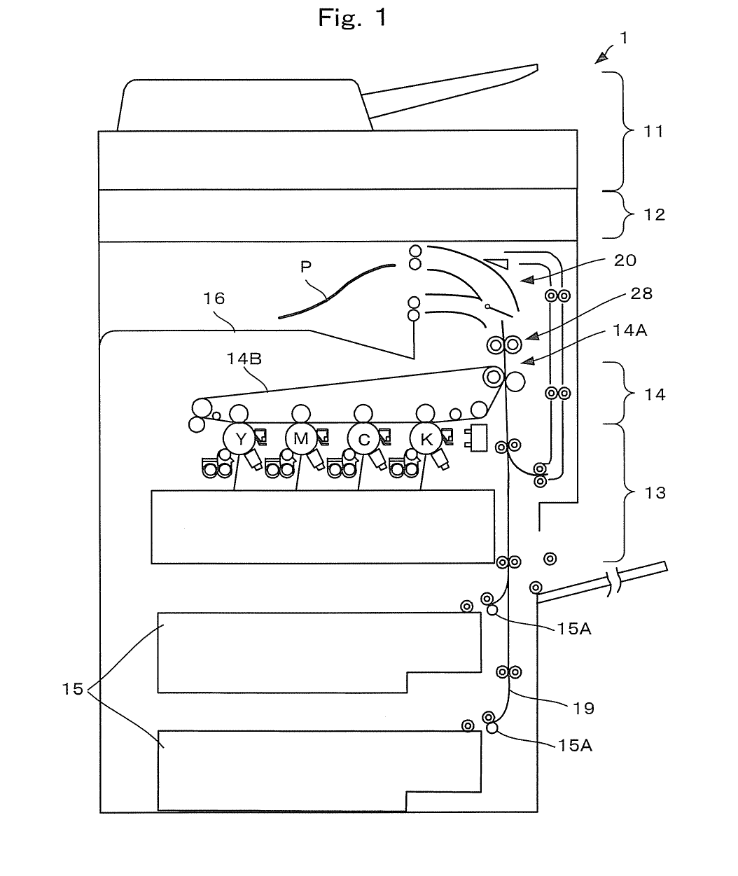

FIG. 1 is a diagram of the configuration of the image forming apparatus 1 according to this embodiment. As shown in FIG. 1, the image forming apparatus 1 includes an auto document feeder 11, an image reading unit 12, an image forming unit 13, a transfer unit 14, a recording-medium conveying mechanism 19, and a paper feeding unit 15.

The image forming apparatus 1 includes the auto document feeder 11 in an upper part of a main body to be capable of opening and closing. The auto document feeder 11 includes a document conveying mechanism configured to extract original documents from a paper feeding tray one by one and convey the original document to a paper discharge tray.

The auto document feeder 11 conveys, with the document conveying mechanism, the original documents to a document reading unit of the image reading unit 12 one by one. It is also possible to open the auto document feeder 11 and place an original document on a document table of the image reading unit 12.

The image reading unit 12 includes a carriage including an exposure lamp for exposing an original document and a first reflection mirror, plural second reflection mirrors locked to a main body frame of the image forming apparatus 1, a lens block, and a CCD (Charge Coupled Device) of an image reading sensor.

The carriage stands still in the document reading unit or reciprocatingly moves under the document table to reflect light of the exposure lamp, which is reflected by the original document, to the first reflection mirror. The plural second reflection mirrors reflect reflected light of the first reflection mirror to the lens block. The lens block outputs the reflected light to the CCD. The CCD converts incident light into an electric signal and outputs the electric signal to the image forming unit 13 as an image signal.

The image forming unit 13 includes, for each of yellow Y, magenta M, cyan C, and black K, a laser irradiating unit, a photoconductive drum as an electrostatic latent image bearing member, and a developer supplying unit.

The laser irradiating unit irradiates a laser beam on the photoconductive drum on the basis of the image signal and forms an electrostatic latent image on the photoconductive drum. The developer supplying unit supplies a developer to the photoconductive drum and forms a developer image from the electrostatic latent image.

The recording-medium conveying mechanism 19 includes, most upstream on the paper feeding unit 15 side, a pickup mechanism 15A configured to extract recording media one by one.

The pickup mechanism 15A extracts recording media from the paper feeding unit 15 one by one and passes the recording medium to the recording-medium conveying mechanism 19. The recording-medium conveying mechanism 19 conveys the recording medium to the transfer unit 14.

The transfer unit 14 includes a transfer belt 14B, a transfer roller 14A, and a fixing device 28. The transfer belt 14B as an image bearing member receives transfer of the developer image on the photoconductive drum and bears the developer image. The transfer roller 14A applies a voltage and transfers the developer image on the transfer belt 14B onto a recording medium conveyed thereto. The fixing device 28 heats and presses the developer image and fixes the developer image on the recording medium.

The image forming apparatus 1 includes a sticking preventing device 20 downstream in a recording medium conveying direction of the fixing device 28. The sticking preventing device 20 discharges, from a paper discharge port, the recording medium passed through the fixing device 28.

A recording medium P discharged from the paper discharge port is stacked on a paper discharge tray 16 that is a carrying unit configured to carry the recording medium.

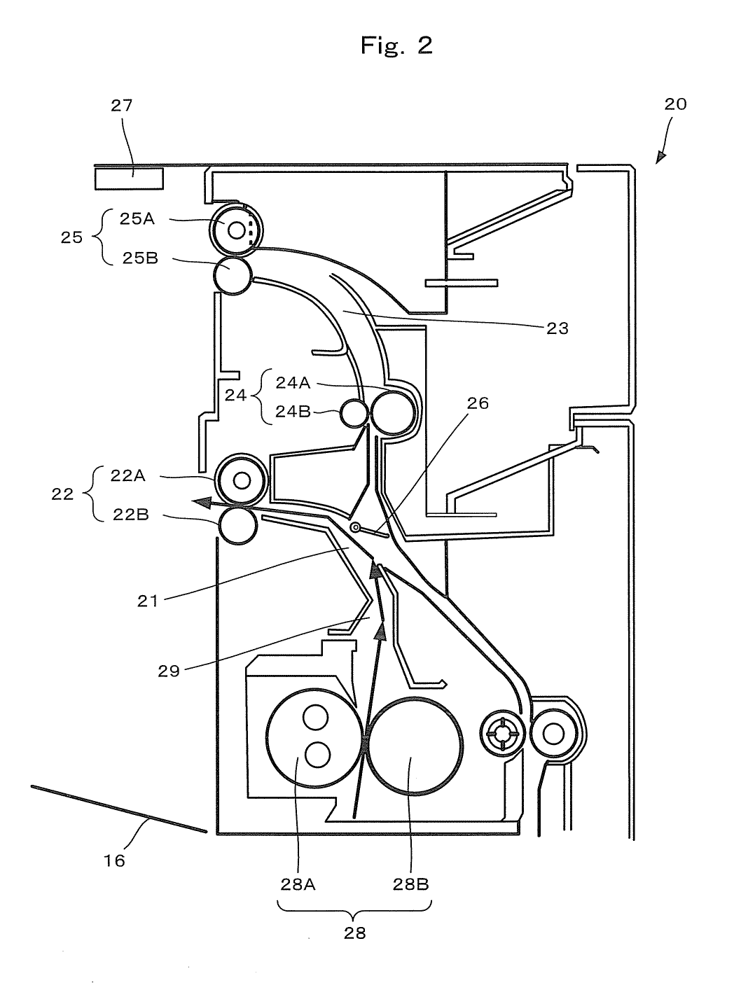

FIG. 2 is a side view of the sticking preventing device 20 in which a recording medium is discharged through a first conveying path 21. As shown in FIG. 2, the image forming apparatus 1 includes the sticking preventing device 20 downstream in the recording medium conveying direction of the fixing device 28 including a heating roller 28A and a pressing roller 28B.

The sticking preventing device 20 includes a main conveying path 29 connected to a recording-medium conveying route downstream in the recording medium conveying direction of the fixing device 28, the first conveying path 21 connected to the main conveying path 29, a second conveying path 23 branching from the main conveying path 29 and having a conveying route longer than that of the first conveying path 21, and a switching device 26 provided at a branching point of the first conveying path 21 and the second conveying path 23 and configured to switch the recording-medium conveying route to the first conveying unit 21 and the second conveying unit 23.

The sticking preventing device 20 includes a temperature sensor 27 above a discharge port of the first conveying path 21 and a discharge port of the second conveying path 23. Specifically, the sticking preventing device 20 includes the temperature sensor 27 in a position where the temperature sensor 27 can detect the temperature of a recording medium discharged from the discharge port of the first conveying path 21 and the temperature of a recording medium discharged from the discharge port of the second conveying path 23. The temperature sensor 27 detects the temperature of the recording medium discharged from the discharge port of the first conveying path 21 and the temperature of the recording medium discharged from the discharge port of the second conveying path 23.

The first conveying path 21 includes a first paper discharge roller 22 having a first driving roller 22A and a first driven roller 22B configured to discharge a recording medium onto the paper discharge tray 16.

The second conveying path 23 includes a second paper discharge roller 25 having a second driving roller 25A and a second driven roller 25B configured to discharge a recording medium onto the paper discharge tray 16 and a conveying roller 24 having a third driving roller 24A and a third driven roller 24B configured to convey the recording medium to the second paper discharge roller 25.

The first paper discharge roller 22, the second paper discharge roller 25, and the conveying roller 24 rotate at the same speed. Therefore, time until the recording medium conveyed through the second conveying path 23 is discharged onto the paper discharge tray 16 through the fixing device 28 is longer than time until the recording medium conveyed through the first conveying path 21 is discharged onto the paper discharge tray 16.

As shown in FIG. 2, the switching device 26 closes an inlet of the second conveying path 23 and opens an inlet of the first conveying path 21 to thereby form a conveying route extending from the fixing device 28 through the first conveying path 21. The image forming apparatus 1 conveys a recording medium through the conveying route indicated by an arrow.

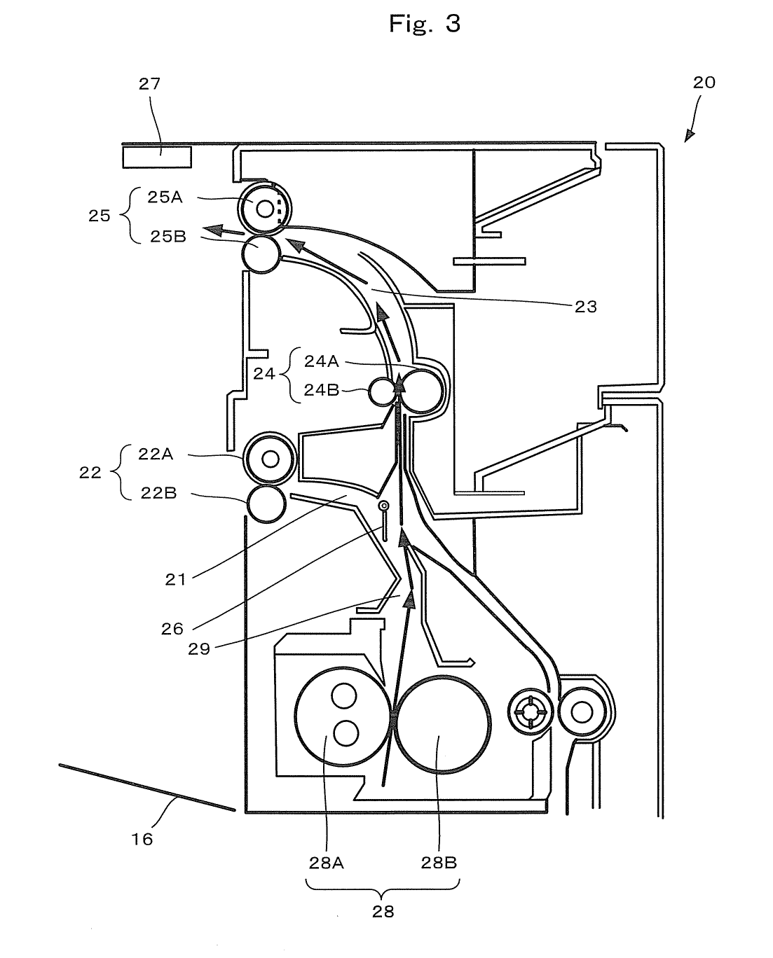

FIG. 3 is a side view of the sticking preventing device 20 in which a recording medium is discharged through the second conveying path 23.

As shown in FIG. 3, the switching device 26 closes the inlet of the first conveying path 21 and opens the inlet of the second conveying path 23 to thereby form a conveying route extending from the fixing device 28 through the second conveying path 23. The image forming apparatus 1 conveys a recording medium through the conveying route indicated by an arrow.

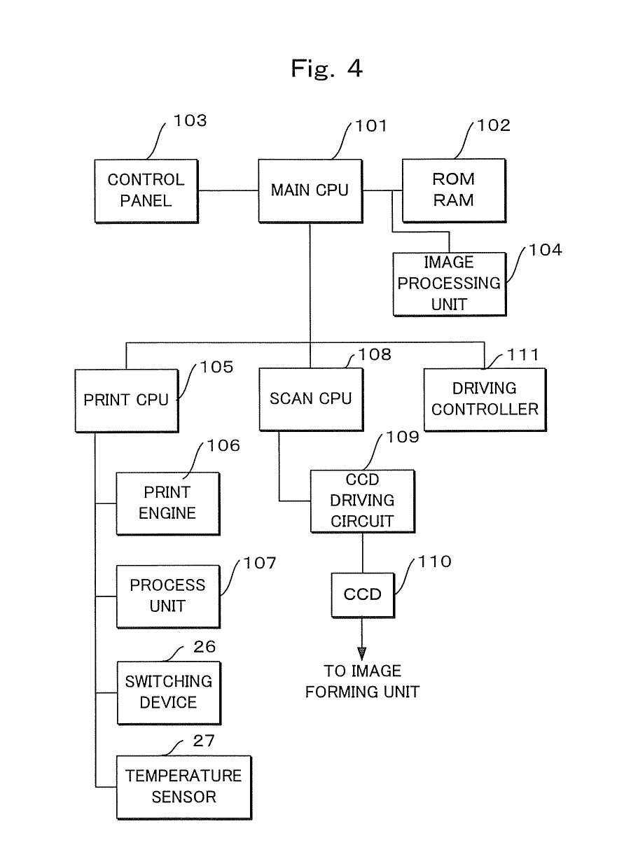

FIG. 4 is a block diagram of the configuration of the image forming apparatus 1. As shown in FIG. 4, the image forming apparatus 1 includes a main CPU 101 configured to collectively control the image forming apparatus 1. The main CPU 101 is connected to a ROM and RAM 102 as a storage device, a control panel 103 as an input and output device, an image processing unit 104 configured to perform image processing, a print CPU 105 configured to control an apparatus that performs image formation, a scan CPU 108 configured to control an apparatus that performs image reading, and a driving controller 111 configured to control a conveying device for a recording medium.

The print CPU 105 as a control unit is connected to a print engine 106 configured to perform image formation, a process unit 107 configured to form an electrostatic latent image, the switching device 26, and the temperature sensor 27.

The scan CPU 108 is connected to a CCD driving circuit 109 configured to drive a CCD 110.

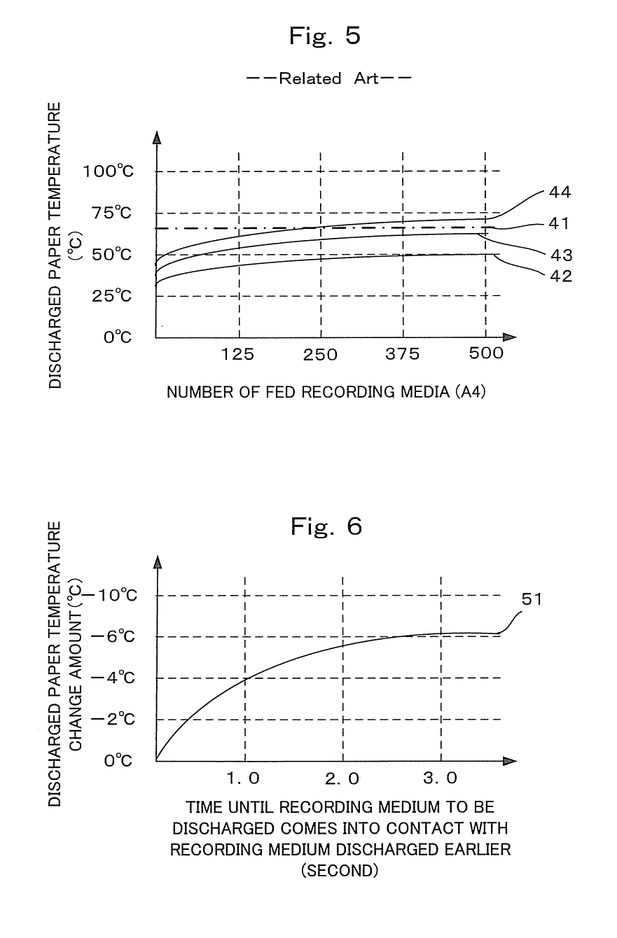

FIG. 5 is a graph of the temperature of a recording medium to be discharged in the related art. A trial for continuously performing duplex printing on five hundred recording media was performed three times at the room temperature (25° C.). A graph 42 indicates a temperature change in the first trial immediately after power-on, a graph 43 indicates a temperature change in the second trial performed following the first trial, and a graph 44 indicates a temperature change in the third trial performed following the second trial.

The ordinate indicates the temperatures of recording media to be discharged and the abscissa indicates the number of fed recording media for duplex printing in the A4 size.

As shown in FIG. 5, during the third trial, the temperature of a recording medium to be discharged exceeds the graph 41 indicating temperature at which sticking occurs.

FIG. 6 is a graph of a temperature change of a recording medium to be discharged in the image forming apparatus 1 according to this embodiment. The ordinate indicates a temperature change amount of the recording media to be discharged and the abscissa indicates time (second) until the recording medium to be discharged comes into contact with a recording medium discharged earlier.

As shown in FIG. 6, the temperature of the recording medium to be discharged falls about 6° C. from temperature at the beginning of discharge in about 3 seconds. Therefore, to prevent sticking by cooling a recording medium, it is effective to extend time until the recording medium is discharged onto the paper discharge tray 16 after passing through the fixing device 28.

### Control of a Conveying Route

### FIRST EMBODIMENT

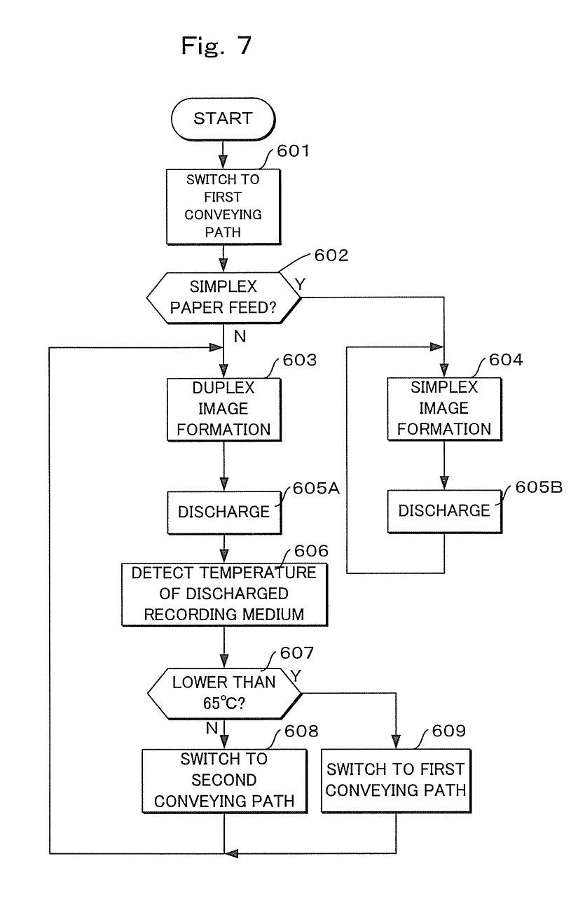

FIG. 7 is a flowchart for explaining control of a conveying route in the image forming apparatus 1 according to a first embodiment. As shown in FIG. 7, in act 601, the image forming apparatus 1 displaces the switching device 26 to close the second conveying path 23 and open the first conveying path 21 and switches the conveying route to discharge a recording medium from the first conveying path 21.

In act 602, the image forming apparatus 1 determines whether a setting input from the control panel 103 by a user is simplex paper feed, i.e., simplex printing. If a setting value is the simplex paper feed, the image forming apparatus 1 proceeds to act 604. If the setting value is not the simplex paper feed, the image forming apparatus 1 proceeds to act 603.

In act 603, the image forming apparatus 1 forms images on both sides of the recording medium and proceeds to act 605A. In act 605A, the image forming apparatus 1 discharges the recording medium having the images formed thereon.

In act 604, the image forming apparatus 1 forms an image on one side of the recording medium and proceeds to act 605B. In act 605B, the image forming apparatus 1 discharges the recording medium having the image formed thereon and returns to act 604.

In act 606, the image forming apparatus 1 detects, with the temperature sensor 27, the temperature of the discharged recording medium.

In act 607, the image forming apparatus 1 determines whether the temperature of the discharged recording medium is lower than 65° C. that is sticking occurrence temperature. Sticking occurs if the temperature of the recording medium to be discharged is equal to or higher than 65° C. The sticking occurrence temperature is set in advance and stored in a storage device. The sticking occurrence temperature can be changed from the control panel 103. If the temperature of the discharged recording medium is lower than 65° C., the image forming apparatus 1 proceeds to act 609. If the temperature of the discharged recording medium is not lower than 65° C., the image forming apparatus 1 proceeds to act 608.

In act 608, the image forming apparatus 1 displaces the switching device 26 to close the first conveying path 21 and open the second conveying path 23 and switches the conveying route to discharge the recording medium from the second conveying path 23. If the conveying route is already formed to discharge the recording medium from the second conveying path 23, the image forming apparatus 1 maintains the position of the switching device 26. Subsequently, the image forming apparatus 1 proceeds to act 603.

In act 609, the image forming apparatus 1 displaces the switching device 26 to close the second conveying path 23 and open the first conveying path 21 and switches the conveying route to discharge the recording medium from the first conveying path 21. If the conveying route is already formed to discharge the recording medium from the first conveying path 21, the image forming apparatus 1 maintains the position of the switching device 26. Subsequently, the image forming apparatus 1 proceeds to act 603.

The image forming apparatus 1 repeats act 603 to act 608 or act 609 in the case of duplex paper feed and repeats act 604 to act 605B in the case of the simplex paper feed until image formation on a designated number of recording media ends.

FIG. 8 is a diagram of a graph 71 of a relation between the temperature of a recording medium to be discharged and the number of fed recording media in the first embodiment. In FIG. 8, the ordinate indicates the temperature (° C.) of the recording medium to be discharged and the abscissa indicates the number of recording media discharged by the duplex paper feed in the A4 size.

As indicated by the graph 71 shown in FIG. 8, the conveying route is switched from the first conveying path to the second conveying path if the number of recording media indicated by an arrow A is discharged. According to this switching, time from a point when the recording medium passes through the fixing device 28 until the recording medium is discharged onto the paper discharge tray 16 is extended. Therefore, the temperature of the recording medium to be discharged falls.

Therefore, it is possible to prevent the temperature of the recording medium to be discharged from reaching the graph 41 indicating the temperature at which sticking occurs.

### Effects of the First Embodiment

As explained above, the image forming apparatus 1 according to this embodiment includes the sticking preventing device 20 including the main conveying path 29 connected from the fixing device 28, the first conveying path 21 connected to the main conveying path 29, the second conveying path 23 branching from the main conveying path 29 and having the conveying route longer than that of the first conveying path 21, the switching device 26 provided at the branching point of the first conveying path 21 and the second conveying path 23 and configured to switch the recording-medium conveying route to the first conveying path 21 and the second conveying path 23, and the temperature sensor 27 provided above the discharge port of the first conveying path 21 and the discharge port of the second conveying path 23, and the control unit configured to, if the temperature of a recording medium to be discharged detected by the temperature sensor 27 is equal to or higher than the temperature at which sticking occurs, displace the switching device 26 to switch the conveying route from the first conveying path 21 to the second conveying path 23.

Therefore, it is possible to, if the temperature of the recording medium to be discharged is lower than the sticking occurrence temperature, discharge the recording medium from the first conveying path from which the recording medium can be quickly discharged and, if the temperature of the recording medium to be discharged is equal to or higher than the sticking occurrence temperature, switch the conveying route to the second conveying path in which time longer than that in the first conveying path is required until the discharge. There is an effect that it is possible to realize quick discharge processing and prevention of sticking.

### SECOND EMBODIMENT

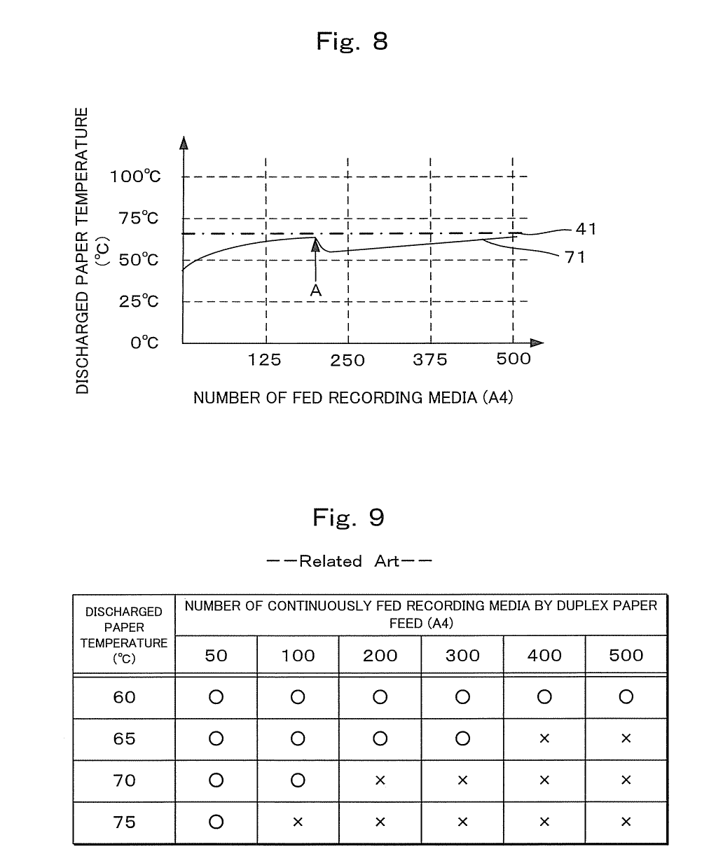

FIG. 9 is a table of sticking occurrence states at the temperatures of recording media to be discharged and the numbers of discharged recording media in the related art. The ordinate indicates discharged paper temperature and the abscissa indicates the number of discharged recording media. As shown in FIG. 9, if the discharged paper temperature as the temperature of a recording medium to be discharged is high temperature exceeding 70° C., sticking occurs even if the number of recording media stacked on the paper discharge tray 16 is two hundred. If the number of recording media stacked on the paper discharge tray 16 exceeds four hundred, sticking occurs even if the discharged paper temperature is relatively low 65° C.

The storage device of the image forming apparatus 1 stores this condition for occurrence of sticking. This sticking occurrence condition can be changed from the control panel 103.

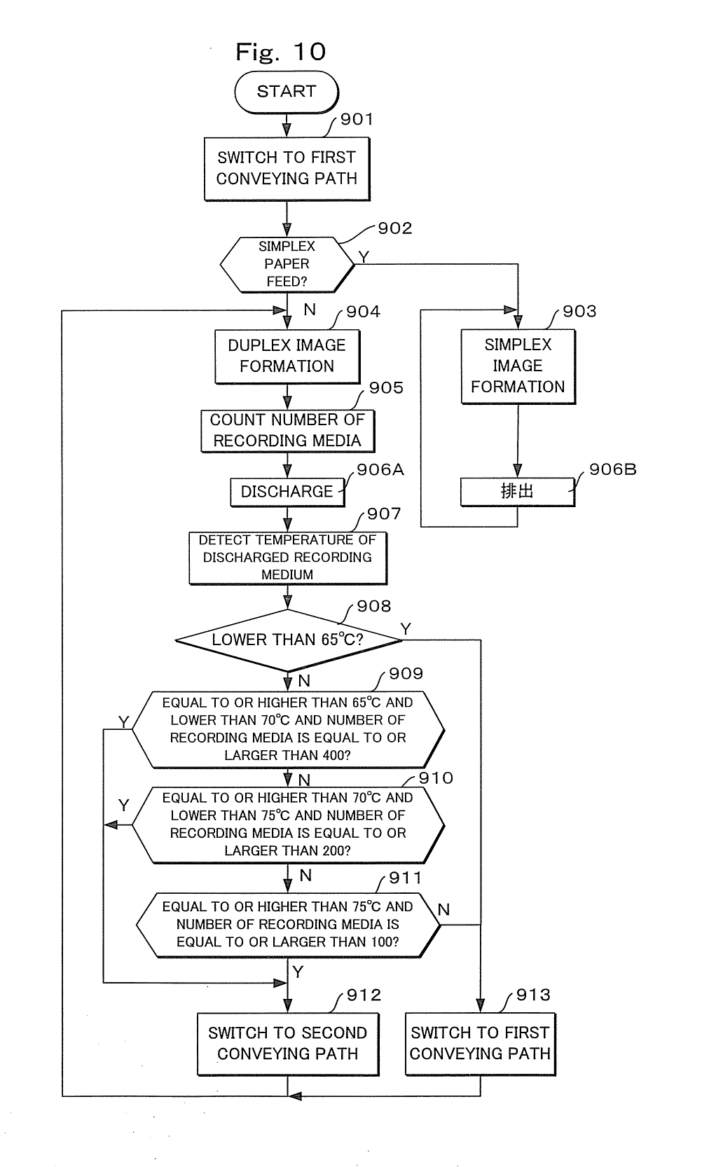

FIG. 10 is a flowchart for explaining control of a conveying route in the image forming apparatus 1 according to a second embodiment. As shown in FIG. 10, in act 901, the image forming apparatus 1 displaces the switching device 26 to close the second conveying path 23 and open the first conveying path 21 and switches the conveying route to discharge a recording medium from the first conveying path 21.

In act 902, the image forming apparatus 1 determines whether a setting input from the control panel 103 by a user is the simplex paper feed, i.e., the simplex printing. If a setting value is the simplex paper feed, the image forming apparatus 1 proceeds to act 903. If the setting value is not the simplex paper feed, the image forming apparatus 1 proceeds to act 904.

In act 903, the image forming apparatus 1 forms an image on one side of the recording medium and proceeds to act 906B. In act 906B, the image forming apparatus 1 discharges the recording medium having the image formed thereon and returns to act 903.

In act 904, the image forming apparatus 1 forms images on both sides of the recording medium and proceeds to act 905.

In act 905, the image forming apparatus 1 counts the number of recording media on which images are formed.

In act 906A, the image forming apparatus 1 discharges the recording medium having the images formed thereon onto the paper discharge tray 16.

In act 907, the image forming apparatus 1 detects the temperature of the recording medium to be discharged with the temperature sensor 27.

In act 908, the image forming apparatus 1 determines whether the temperature of the recording medium to be discharged is lower than 65° C. If the temperature of the recording medium is lower than 65° C., the image forming apparatus 1 proceeds to act 913. If the temperature of the recording medium is not lower than 65° C., the image forming apparatus 1 proceeds to act 909.

In act 913, the image forming apparatus 1 displaces the switching device 26 to close the second conveying path 23 and open the first conveying path 21 and switches the conveying route to discharge the recording medium from the first conveying path 21. If the conveying route is already formed to discharge the recording medium from the first conveying path 21, the image forming apparatus 1 maintains the position of the switching device 26. Subsequently, the image forming apparatus 1 proceeds to act 904.

In act 909, the image forming apparatus 1 determines whether the temperature of the recording medium to be discharged is equal to or higher than 65° C. and lower than 70° C. and the number of discharged recording media is equal to or larger than four hundred. If the temperature of the recording medium to be discharged is equal to or higher than 65° C. and lower than 70° C. and the number of discharged recording media is equal to or larger than four hundred, the image forming apparatus 1 proceeds to act 912. If this condition is not satisfied, the image forming apparatus 1 proceeds to act 910.

In act 910, the image forming apparatus 1 determines whether the temperature of the recording medium to be discharged is equal to or higher than 70° C. and lower than 75° C. and the number of discharged recording media is equal to or larger than two hundred. If the temperature of the recording medium to be discharged is equal to or higher than 70° C. and lower than 75° C. and the number of discharged recording media is equal to or larger than two hundred, the image forming apparatus 1 proceeds to act 912. If this condition is not satisfied, the image forming apparatus 1 proceeds to act 911.

In act 911, the image forming apparatus 1 determines whether the temperature of the recording medium to be discharged is equal to or higher than 75° and the number of discharged recording media is equal to or larger than one hundred. If the temperature of the recording medium to be discharged is equal to or higher than 75° C. and the number of discharged recording media is equal to or larger than one hundred, the image forming apparatus 1 proceeds to act 912. If this condition is not satisfied, the image forming apparatus 1 proceeds to act 913.

In act 912, the image forming apparatus 1 displaces the switching device 26 to close the first conveying path 21 and open the second conveying path 23 and switches the conveying route to discharge the recording medium from the second conveying path 23. If the conveying route is already formed to discharge the recording medium from the second conveying path 23, the image forming apparatus 1 maintains the position of the switching device 26. Subsequently, the image forming apparatus 1 proceeds to act 904.

The image forming apparatus 1 repeats act 904 to act 912 or act 913 in the case of the duplex paper feed and repeats act 903 to act 906B in the case of the simplex paper feed until image formation on a designated number of recording media ends.

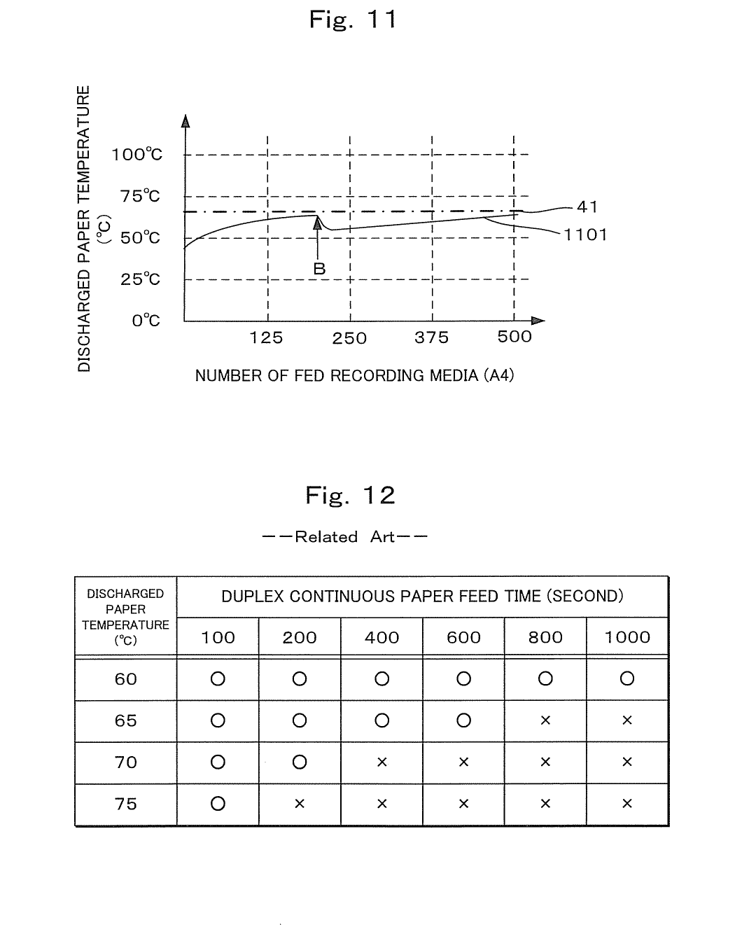

FIG. 11 is a diagram of a graph 1101 of a relation between the temperature of a recording medium to be discharged and the number of fed recording media in the second embodiment. In FIG. 11, the ordinate indicates the temperature (° C.) of the recording medium to be discharged and the abscissa indicates the number of recording media to be discharged by the duplex paper feed in the A4 size.

As indicated by the graph 1101 shown in FIG. 11, the conveying route is switched from the first conveying path to the second conveying path if the number of recording media indicated by an arrow B is discharged. According to this switching, time from a point when the recording medium passes through the fixing device 28 until the recording medium is discharged onto the paper discharge tray 16 is extended. Therefore, the temperature of the recording medium to be discharged falls.

Therefore, it is possible to prevent the temperature of the recording medium to be discharged from reaching the graph 41 indicating the temperature at which sticking occurs.

### Effects of the Second Embodiment

As explained above, the image forming apparatus 1 according to this embodiment includes the sticking preventing device 20 and the control unit configured to, if a relation between the number of recording media to be discharged and the temperature of the recording medium to be discharged detected by the temperature sensor 27 satisfies the condition for occurrence of sticking, displace the switching device 26 to switch the conveying route from the first conveying path to the second conveying path.

Therefore, it is possible to, if the relation between the number of recording media to be discharged and the temperature of the recording medium to be discharged does not satisfy the condition for occurrence of sticking, discharge the recording medium from the first conveying path from which the recording medium can be quickly discharged and, if the relation satisfies the condition for occurrence of sticking, switch the conveying route to the second conveying path in which time longer than that in the first conveying path is required until the discharge. There is an effect that it is possible to realize quick discharge processing and prevention of sticking.

### THIRD EMBODIMENT

FIG. 12 is a table of sticking occurrence states at time for continuous paper feed on both sides and the numbers of discharged recording media in the related art. The ordinate indicates discharged paper temperature and the abscissa indicates continuous paper feed time for recording media. As shown in FIG. 12, if the discharged paper temperature as the temperature of a recording medium to be discharged is high temperature exceeding 75° C., sticking occurs even if the continuous paper feed time is 200 seconds. IF the continuous paper feed time exceeds 800 seconds, sticking occurs even if the discharged paper temperature is relatively low 65° C.

The storage device of the image forming apparatus 1 stores this condition for occurrence of sticking. This sticking occurrence condition can be changed from the control panel 103.

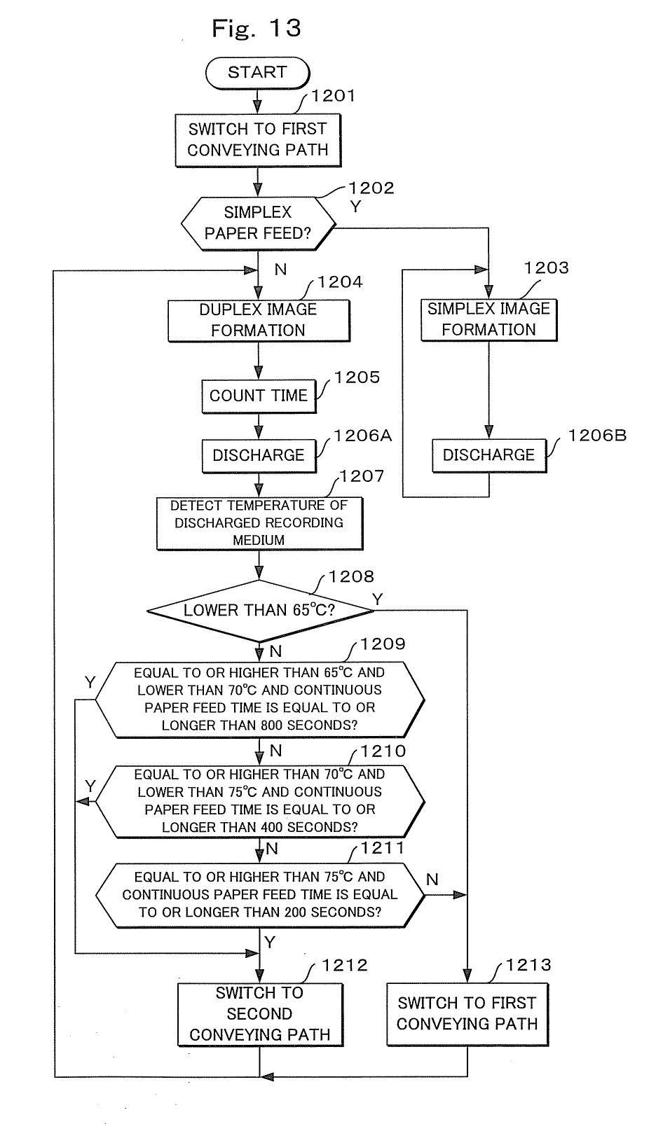

FIG. 13 is a flowchart for explaining control of a conveying route in the image forming apparatus 1 according to a third embodiment. As shown in FIG. 13, in act 1201, the image forming apparatus 1 displaces the switching device 26 to close the second conveying path 23 and open the first conveying path 21 and switches the conveying route to discharge a recording medium from the first conveying path 21.

In act 1202, the image forming apparatus 1 determines whether a setting input from the control panel 103 by a user is the simplex paper feed, i.e., the simplex printing. If a setting value is the simplex paper feed, the image forming apparatus 1 proceeds to act 1203. If the setting value is not the simplex paper feed, the image forming apparatus 1 proceeds to act 1204.

In act 1203, the image forming apparatus 1 forms an image on one side of the recording medium and proceeds to act 1206B. In act 1206B, the image forming apparatus 1 discharges the recording medium having the image formed thereon and returns to act 1203.

In act 1204, the image forming apparatus 1 forms images on both sides of the recording medium and proceeds to act 1205.

In act 1205, the image forming apparatus 1 counts time in which images are continuously formed. In act 1206A, the image forming apparatus 1 discharges the recording medium having the images formed thereon onto the paper discharge tray 16.

In act 1207, the image forming apparatus 1 detects the temperature of the recording medium to be discharged with the temperature sensor 27.

In act 1208, the image forming apparatus 1 determines whether the temperature of the recording medium to be discharged is lower than 65° C. If the temperature of the recording medium is lower than 65° C., the image forming apparatus 1 proceeds to act 1213. If the temperature of the recording medium is not lower than 65° C., the image forming apparatus 1 proceeds to act 1209.

In act 1213, the image forming apparatus 1 displaces the switching device 26 to close the second conveying path 23 and open the first conveying path 21 and switches the conveying route to discharge the recording medium from the first conveying path 21. If the conveying route is already formed to discharge the recording medium from the first conveying path 21, the image forming apparatus 1 maintains the position of the switching device 26. Subsequently, the image forming apparatus 1 proceeds to act 1204.

In act 1209, the image forming apparatus 1 determines whether the temperature of the recording medium to be discharged is equal to or higher than 65° C. and lower than 70° C. and the continuous paper feed time is equal to or longer than 800 seconds. If the temperature of the recording medium to be discharged is equal to or higher than 65° C. and lower than 70° C. and the continuous paper feed time is equal to or longer than 800 seconds, the image forming apparatus 1 proceeds to act 1212. If this condition is not satisfied, the image forming apparatus 1 proceeds to act 1210.

In act 1210, the image forming apparatus 1 determines whether the temperature of the recording medium to be discharged is equal to or higher than 70° C. and lower than 75° C. and the continuous paper feed time is equal to or longer than 400 seconds. If the temperature of the recording medium to be discharged is equal to or higher than 70° C. and lower than 75° C. and the continuous paper feed time is equal to or longer than 400 seconds, the image forming apparatus 1 proceeds to act 1212. If this condition is not satisfied, the image forming apparatus 1 proceeds to act 1211.

In act 1211, the image forming apparatus 1 determines whether the temperature of the recording medium to be discharged is equal to or higher than 75° C. and the continuous paper feed time is equal to or longer than 200 seconds. If the temperature of the recording medium to be discharged is equal to or higher than 75° C. and the continuous paper feed time is equal to or longer than 200 seconds, the image forming apparatus 1 proceeds to act 1212. If this condition is not satisfied, the image forming apparatus 1 proceeds to act 1213.

In act 1212, the image forming apparatus 1 displaces the switching device 26 to close the first conveying path 21 and open the second conveying path 23 and switches the conveying route to discharge the recording medium from the second conveying path 23. If the conveying route is already formed to discharge the recording medium from the second conveying path 23, the image forming apparatus 1 maintains the position of the switching device 26. Subsequently, the image forming apparatus 1 proceeds to act 1204.

The image forming apparatus 1 repeats act 1204 to act 1212 or act 1213 in the case of the duplex paper feed and repeats act 1203 to act 1206B in the case of the simplex paper feed until image formation for a designated number of recording media ends.

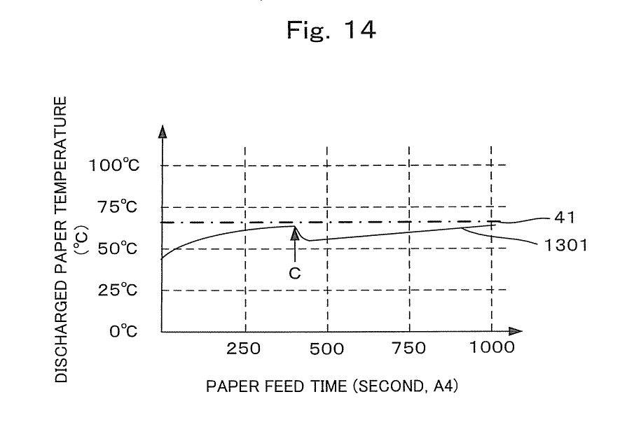

FIG. 14 is a diagram of a graph 1301 of a relation between the temperature of a recording medium to be discharged and the number of fed recording media in the third embodiment. In FIG. 14, the ordinate indicates the temperature (° C.) of the recording medium to be discharged and the abscissa indicates continuous paper feed time (second) of recording media discharged by the duplex paper feed in the A4 size.

As indicated by the graph 1301 shown in FIG. 14, the conveying route is switched from the first conveying path to the second conveying path if the number of recording media indicated by an arrow C is discharged. According to this switching, time from a point when the recording medium passes through the fixing device 28 until the recording medium is discharged onto the paper discharge tray 16 is extended. Therefore, the temperature of the recording medium to be discharged falls.

Therefore, it is possible to prevent the temperature of the recording medium to be discharged from reaching the graph 41 indicating the temperature at which sticking occurs.

### Effects of the Third Embodiment

As explained above, the image forming apparatus 1 according to this embodiment includes the sticking preventing device 20 and the control unit configured to, if a relation between continuous paper feed time of recording media to be discharged and the temperature of the recording medium to be discharged detected by the temperature sensor 27 satisfies the condition for occurrence of sticking, displace the switching device 26 to switch the conveying route from the first conveying path to the second conveying path.

Therefore, it is possible to, if the relation between the continuous paper feed time of the recording media to be discharged and the temperature of the recording medium to be discharged detected by the temperature sensor 27 does not satisfy the condition for occurrence of sticking, discharge the recording medium from the first conveying path from which the recording medium can be quickly discharged and, if the relation satisfies the condition for occurrence of sticking, switch the conveying route to the second conveying path in which time longer than that in the first conveying path is required until the discharge. There is an effect that it is possible to realize quick discharge processing and prevention of sticking.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. A sticking preventing device comprising:
a main conveying path connected to a recording-medium conveying route downstream in a recording medium conveying direction of a fixing device;
a first conveying path connected to the main conveying path;
a second conveying path branching from the main conveying path and having a conveying route longer than that of the first conveying path;
a switching device provided at a branching point of the first conveying path and the second conveying path and configured to switch the recording-medium conveying route to the first conveying path and the second conveying path; and
a temperature sensor provided above a discharge port of the first conveying path and a discharge port of the second conveying path and configured to detect temperature of a recording medium to be discharged.

2. The device according to claim 1, wherein, according to control by a control unit of an image forming apparatus including the sticking preventing device, the sticking preventing device switches, if the temperature of the recording medium to be discharged detected by the temperature sensor is equal to or higher than temperature set in advance, the recording-medium conveying route from the first conveying path to the second conveying path.

3. The device according to claim 1, wherein, according to control by a control unit of an image forming apparatus including the sticking preventing device, the sticking preventing device switches, if the temperature of the recording medium to be discharged detected by the temperature sensor is equal to or higher than the temperature set in advance, the recording-medium conveying route from the first conveying path to the second conveying path and switches, if the temperature of the recording medium to be discharged detected by the temperature sensor is lower than the temperature set in advance, the recording-medium conveying route from the second conveying path to the first conveying path.

4. The device according to claim 1, wherein, according to control by a control unit of an image forming apparatus including the sticking preventing device, the sticking preventing device switches, if a relation between a number of the recording media to be discharged and the temperature of the recording medium to be discharged detected by the temperature sensor satisfies a sticking occurrence condition set in advance, the recording-medium conveying route from the first conveying path to the second conveying path.

5. The device according to claim 1, wherein, according to control by a control unit of an image forming apparatus including the sticking preventing device, the sticking preventing device switches, if a relation between a number of the recording media to be discharged and the temperature of the recording medium to be discharged detected by the temperature sensor satisfies a sticking occurrence condition set in advance, the recording-medium conveying route from the first conveying path to the second conveying path and switches, if the relation between the number of the recording media to be discharged and the temperature of the recording medium to be discharged detected by the temperature sensor does not satisfy the sticking occurrence condition set in advance, the recording-medium conveying route from the second conveying path to the first conveying path.

6. The device according to claim 1, wherein, according to control by a control unit of an image forming apparatus including the sticking preventing device, the sticking preventing device switches, if a relation between continuous paper feed time of the recording medium to be discharged and the temperature of the recording medium to be discharged detected by the temperature sensor satisfies a sticking occurrence condition set in advance, the recording-medium conveying route from the first conveying path to the second conveying path.

7. The device according to claim 1, wherein, according to control by a control unit of an image forming apparatus including the sticking preventing device, the sticking preventing device switches, if a relation between continuous paper feed time of the recording medium to be discharged and the temperature of the recording medium to be discharged detected by the temperature sensor satisfies a sticking occurrence condition set in advance, the recording-medium conveying route from the first conveying path to the second conveying path and switches, if the relation between the continuous paper feed time of the recording medium to be discharged and the temperature of the recording medium to be discharged detected by the temperature sensor does not satisfy the sticking occurrence condition set in advance, the recording-medium conveying route from the second conveying path to the first conveying path.

8. An image forming apparatus comprising:
an image forming unit configured to form an image on a recording medium;
a fixing device configured to heat and press the recording medium having the image formed thereon;
a main conveying path connected to a recording-medium conveying route downstream in a recording medium conveying direction of the fixing device;
a first conveying path connected to the main conveying path;
a second conveying path branching from the main conveying path and having a conveying route longer than that of the first conveying path;
a switching device provided at a branching point of the first conveying path and the second conveying path and configured to switch the recording-medium conveying route to the first conveying path and the second conveying path;
a temperature sensor provided above a discharge port of the first conveying path and a discharge port of the second conveying path and configured to detect temperature of the recording medium to be discharged; and
a control unit configured to control the switching device.

9. The apparatus according to claim 8, wherein the control unit switches, if the temperature of the recording medium to be discharged detected by the temperature sensor is equal to or higher than temperature set in advance, the recording-medium conveying route from the first conveying path to the second conveying path.

10. The apparatus according to claim 8, wherein the control unit switches, if the temperature of the recording medium to be discharged detected by the temperature sensor is equal to or higher than the temperature set in advance, the recording-medium conveying route from the first conveying path to the second conveying path and switches, if the temperature of the recording medium to be discharged detected by the temperature sensor is lower than the temperature set in advance, the recording-medium conveying route from the second conveying path to the first conveying path.

11. The apparatus according to claim 8, wherein the control unit switches, if a relation between a number of the recording media to be discharged and the temperature of the recording medium to be discharged detected by the temperature sensor satisfies a sticking occurrence condition set in advance, the recording-medium conveying route from the first conveying path to the second conveying path.

12. The apparatus according to claim 8, wherein the control unit switches, if a relation between a number of the recording media to be discharged and the temperature of the recording medium to be discharged detected by the temperature sensor satisfies a sticking occurrence condition set in advance, the recording-medium conveying route from the first conveying path to the second conveying path and switches, if the relation between the number of the recording media to be discharged and the temperature of the recording medium to be discharged detected by the temperature sensor does not satisfy the sticking occurrence condition set in advance, the recording-medium conveying route from the second conveying path to the first conveying path.

13. The apparatus according to claim 8, wherein the control unit switches, if a relation between continuous paper feed time of the recording medium to be discharged and the temperature of the recording medium to be discharged detected by the temperature sensor satisfies a sticking occurrence condition set in advance, the recording-medium conveying route from the first conveying path to the second conveying path.

14. The apparatus according to claim 8, wherein the control unit switches, if a relation between continuous paper feed time of the recording medium to be discharged and the temperature of the recording medium to be discharged detected by the temperature sensor satisfies a sticking occurrence condition set in advance, the recording-medium conveying route from the first conveying path to the second conveying path and switches, if the relation between the continuous paper feed time of the recording medium to be discharged and the temperature of the recording medium to be discharged detected by the temperature sensor does not satisfy the sticking occurrence condition set in advance, the recording-medium conveying route from the second conveying path to the first conveying path.

15. An image forming method for an image forming apparatus, comprising switching, if temperature of a recording medium to be discharged detected by a temperature sensor is equal to or higher than temperature set in advance, a recording-medium conveying route from a first conveying path to a second conveying path having a conveying route longer than that of the first conveying path.

16. The method according to claim 15, further comprising switching, if the temperature of the recording medium to be discharged detected by the temperature sensor is equal to or higher than the temperature set in advance, the recording-medium conveying route from the first conveying path to the second conveying path and switching, if the temperature of the recording medium to be discharged detected by the temperature sensor is lower than the temperature set in advance, the recording-medium conveying route from the second conveying path to the first conveying path.

17. The method according to claim 15, further comprising switching, if a relation between a number of the recording media to be discharged and the temperature of the recording medium to be discharged detected by the temperature sensor satisfies a sticking occurrence condition set in advance, the recording-medium conveying route from the first conveying path to the second conveying path.

18. The method according to claim 15, further comprising switching, if a relation between a number of the recording media to be discharged and the temperature of the recording medium to be discharged detected by the temperature sensor satisfies a sticking occurrence condition set in advance, the recording-medium conveying route from the first conveying path to the second conveying path and switching, if the relation between the number of the recording media to be discharged and the temperature of the recording medium to be discharged detected by the temperature sensor does not satisfy the sticking occurrence condition set in advance, the recording-medium conveying route from the second conveying path to the first conveying path.

19. The method according to claim 15, further comprising switching, if a relation between continuous paper feed time of the recording medium to be discharged and the temperature of the recording medium to be discharged detected by the temperature sensor satisfies a sticking occurrence condition set in advance, the recording-medium conveying route from the first conveying path to the second conveying path.

20. The method according to claim 15, further comprising unit switching, if a relation between continuous paper feed time of the recording medium to be discharged and the temperature of the recording medium to be discharged detected by the temperature sensor satisfies a sticking occurrence condition set in advance, the recording-medium conveying route from the first conveying path to the second conveying path and switching, if the relation between the continuous paper feed time of the recording medium to be discharged and the temperature of the recording medium to be discharged detected by the temperature sensor does not satisfy the sticking occurrence condition set in advance, the recording-medium conveying route from the second conveying path to the first conveying path.
